(19) United States
(12) Patent Application Publication
(10) Pub. No.: US 2011/0082399 A1
(43) Pub. Date: Apr. 7, 2011

(54) HORIZONTAL VIBRATION APPARATUS

(75) Inventor: Don-Lon Yeh, Taichung City (TW)

(73) Assignee: SIN LIN TECHNOLOGY CO., LTD., Taichung City (TW)

(21) Appl. No.: 12/573,149

(22) Filed: Oct. 4, 2009

(51) Int. Cl. A61H 23/00

(52) U.S. Cl. 601/52; 601/51

(57) ABSTRACT

A horizontal vibration apparatus includes a stand and a vibration machine movably mounted on the stand. The vibration machine has an actuating device mounted therein. The actuating device includes a motor mounted on the stand, a vibrating seat mounted on the stand and relatively connecting to the motor, and an arm mounted on the vibrating seat and connected to the vibration machine. Two wheel assemblies are respectively mounted two sides of the stand for stabilizing the horizontal vibration of the vibration machine.

### BACKGROUND OF THE INVENTION

1. Field of the Invention

The present invention relates to a medical apparatus, and more particularly to a horizontal vibration apparatus.

2. Description of Related Art

A conventional medical apparatus in accordance with the prior art includes a pad and a coupler assembly connected to the pad. A transmission device is connected to the coupler assembly for providing an actuation force. A beating device is mounted on the pad for massaging a patient. The beating device includes multiple beating boards movably mounted thereon for slightly beating the patient. Therefore, the conventional medical machine is provided for preventing the patient from bedsore.

However, the conventional medical apparatus needs a lot of beating boards for corresponding to every part of the patient. The structure of the conventional medical apparatus is complex. The manufacturing fee of the conventional medical machine costs a lot. It is not possible for the beating boards exactly corresponding to every part of different patients. Furthermore, an unnecessary vibration is created due to the transmission device lacks a stabilizing mechanism. The unnecessary vibration causes the patient having an unpleasant feeling. The conventional medical apparatus is worn by the unnecessary vibration after a long time usage.

The present invention has arisen to mitigate and/or obviate the disadvantages of the conventional medical apparatus.

### SUMMARY OF THE INVENTION

The main objective of the present invention is to provide an improved horizontal vibration apparatus for proving a smoothly horizontal vibration effect.

To achieve the objective, the horizontal vibration apparatus in accordance with the present invention comprises a stand and a vibration machine movably mounted on the stand. The vibration machine has at least one rail respectively mounted two sides thereof. The vibration machine has an actuating device mounted therein. The actuating device comprises a motor mounted on the stand, a vibrating seat mounted on the stand and relatively connecting to the motor, and an arm mounted on the vibrating seat and connected to the vibration machine. The motor provides for generating power and relatively driving the vibration seat. The vibrating seat provides for converting the power generated by motor to a horizontal vibration. The arm transmits the horizontal vibration from the vibrating seat to the vibration machine such that the vibration machine is horizontally moved relative to the stand. The actuating device has a decelerator mounted on the stand and positioned between the motor and the vibrating seat. The decelerator is relatively connected to the motor and the vibrating seat. The decelerator provides for adjusting the power generated by the motor and transmitting the adjusted power to the vibrating seat.

Two wheel assemblies are respectively mounted two sides of the stand. The two wheel assemblies are mirror images of each other. The two wheel assemblies respectively meshes with the at least one rail on the two sides of the vibration machine. Each wheel assembly has two wheel sets respectively mounted on two ends of the at least one rail. The two wheel sets of the same wheel assembly are mirror images of each other. Each wheel set has at least two wheels mounted therein. The at least two wheels of the same wheel set respectively mesh two reverse sides of the at least one rail for stabilizing the horizontal vibration of the vibration machine. Each wheel set has a rail mounted on the vibration machine, a first wheel seat mounted on the stand, and two second wheel seats mounted on the stand and respectively positioned on two sides of the first wheel seat. The first wheel seat has a vertical length longer than that of each of the two second wheel seats. The first wheel seat has an upper wheel rotatably mounted therein. Each second wheel seat has a lower wheel rotatably mounted therein. The upper wheel and the two lower wheels of the same wheel set are respectively positioned on two reverse sides of the rail for cooperatively securely meshing the rail.

In accordance with another aspect of the present invention, each wheel set has a wheel seat mounted on the stand and being adjacent to the distal end of the at least one rail. The wheel seat has a lower wheel rotatably mounted therein. The wheel seat has two ears upwardly extended therefrom and an upper wheel rotatably mounted between the two ears. The lower wheel is adjacent to the distal end of the at least one rail.

In accordance with another aspect of the present invention, each wheel set has a wheel seat mounted on the stand and being adjacent to the distal end of the at least one rail. Each wheel seat has a lower wheel rotatably mounted in a lower part thereof and an upper wheel rotatably mounted in an upper part thereof. The lower wheel is vertically aligned with the upper wheel.

In accordance with another aspect of the present invention, each wheel set has a first wheel seat and a second wheel seat mounted on the stand. The second wheel seat is adjacent to a distal end of the at least one rail. The first wheel seat has a vertical length longer than that of the second wheel seat. The first wheel seat has a first wheel rotatably mounted on a top thereof and the second wheel seat of the same wheel set has a second wheel rotatably mounted on a top thereof.

In accordance with another aspect of the present invention, each of the first wheel assembly and the second wheel assembly has a third wheel seat mounted on the stand and positioned between the two wheel sets. The third wheel seat has a same vertical length with that of the second wheel seat of each wheel set. The third wheel seat has a third wheel rotatably mounted on a top thereof for meshing a middle of the first rail.

In accordance with another aspect of the present invention, each wheel has a first wheel seat and a second wheel seat mounted on the stand. The first wheel seat is adjacent to a distal end of the at least one rail. The first wheel seat has a vertical length longer than that of the second wheel seat. The first wheel seat has a first wheel rotatably mounted on a top thereof and the second wheel seat has a second wheel rotatably mounted on a top thereof.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a horizontal vibration apparatus in accordance with the present invention;

FIG. 2 is a partial enlarged perspective view of an actuating device of the horizontal vibration apparatus in FIG. 1;

FIG. 3 is a partial enlarged perspective view of a vibrating seat of the horizontal vibration apparatus in FIG. 2;

FIG. 4 is the perspective view of the horizontal vibration apparatus in accordance with the present invention;

FIG. 5 is a partial enlarged perspective view of a wheel set of the horizontal vibration apparatus in FIG. 4;

FIG. 6 is a side plane view of the horizontal vibration apparatus in accordance with the present invention;

FIG. 7 is a top plane view of the horizontal vibration apparatus in accordance with the present invention;

FIG. 8 is a perspective view of a second embodiment of the horizontal vibration apparatus in accordance with the present invention;

FIG. 9 is a partial enlarged perspective view of a wheel set of the horizontal vibration apparatus in FIG. 8;

FIG. 10 is a side plane view of the second embodiment of the horizontal vibration apparatus in accordance with the present invention;

FIG. 11 is a perspective view of a third embodiment of the horizontal vibration apparatus in accordance with the present invention;

FIG. 12 is a side plane view of the third embodiment of the horizontal vibration apparatus in accordance with the present invention;

FIG. 13 is a perspective view of a fourth embodiment of the horizontal vibration apparatus in accordance with the present invention;

FIG. 14 is a partial enlarged perspective view of a wheel set of the fourth embodiment of the horizontal vibration apparatus in FIG. 13;

FIG. 15 is a side plane view of the fourth embodiment of the horizontal vibration apparatus in accordance with the present invention;

FIG. 16 is a perspective view of a fifth embodiment of the horizontal vibration apparatus in accordance with the present invention;

FIG. 17 is a perspective view of a sixth embodiment of the horizontal vibration apparatus in accordance with the present invention; and

FIG. 18 is a side plane view of the sixth embodiment of the horizontal vibration apparatus in accordance with the present invention.

### DETAILED DESCRIPTION OF THE INVENTION

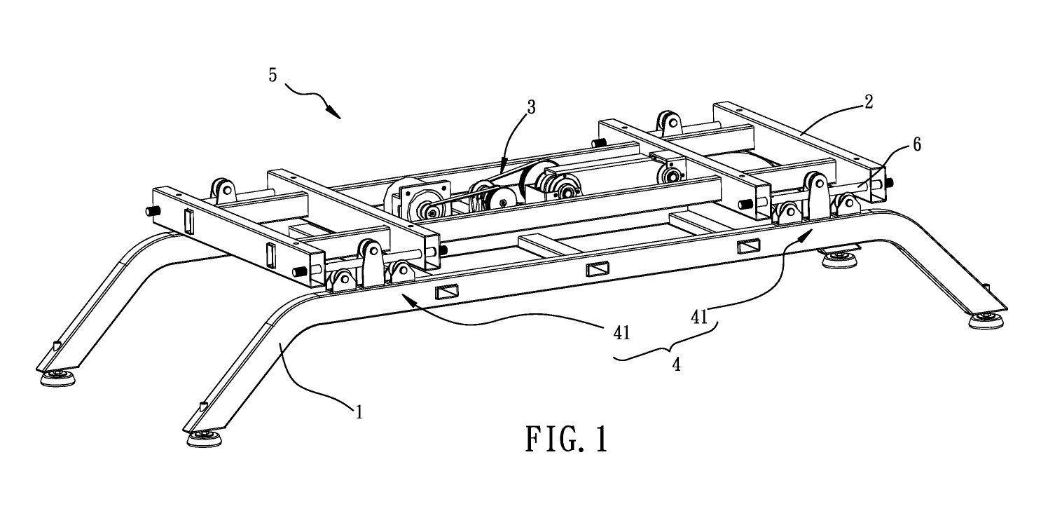

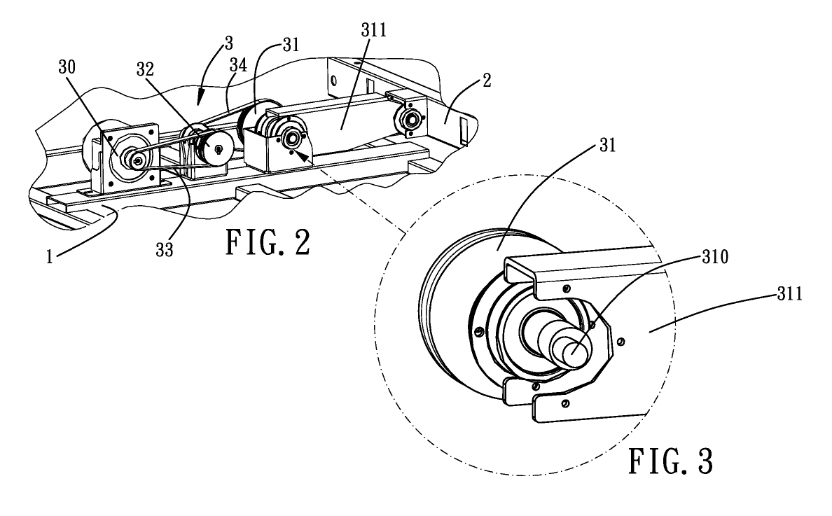

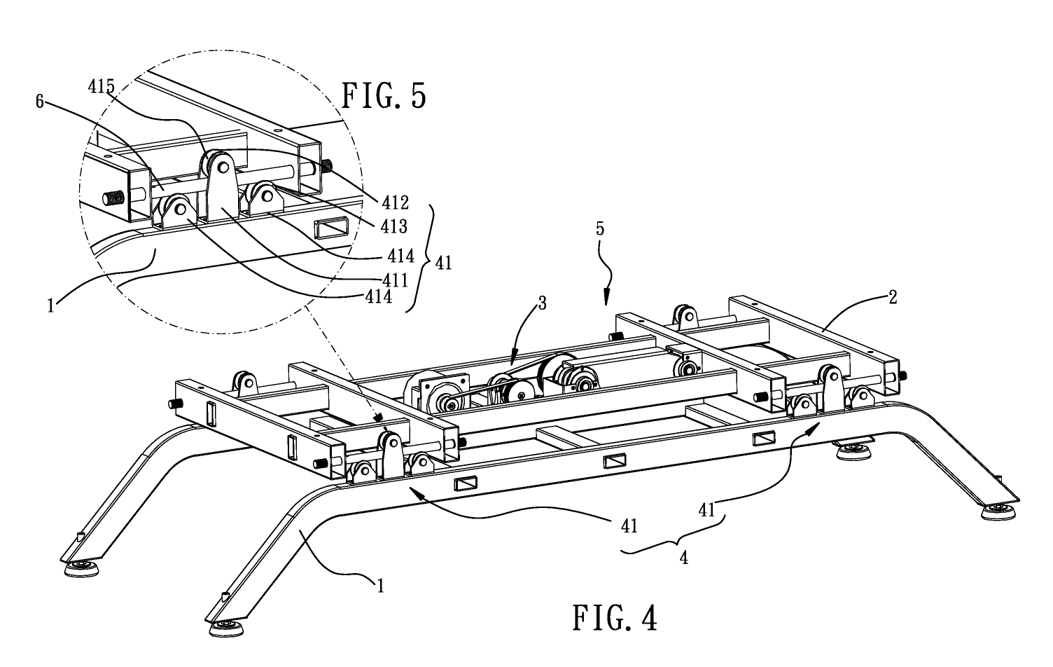

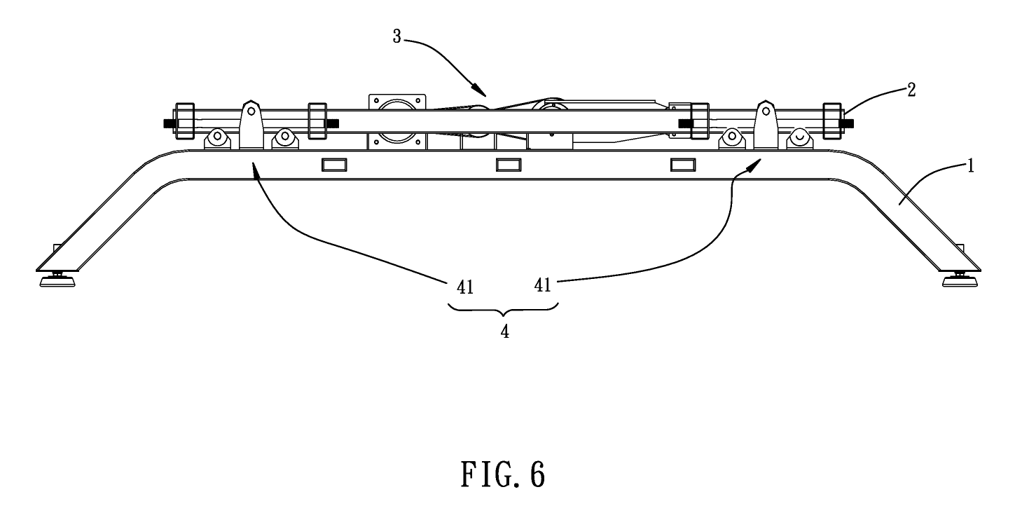

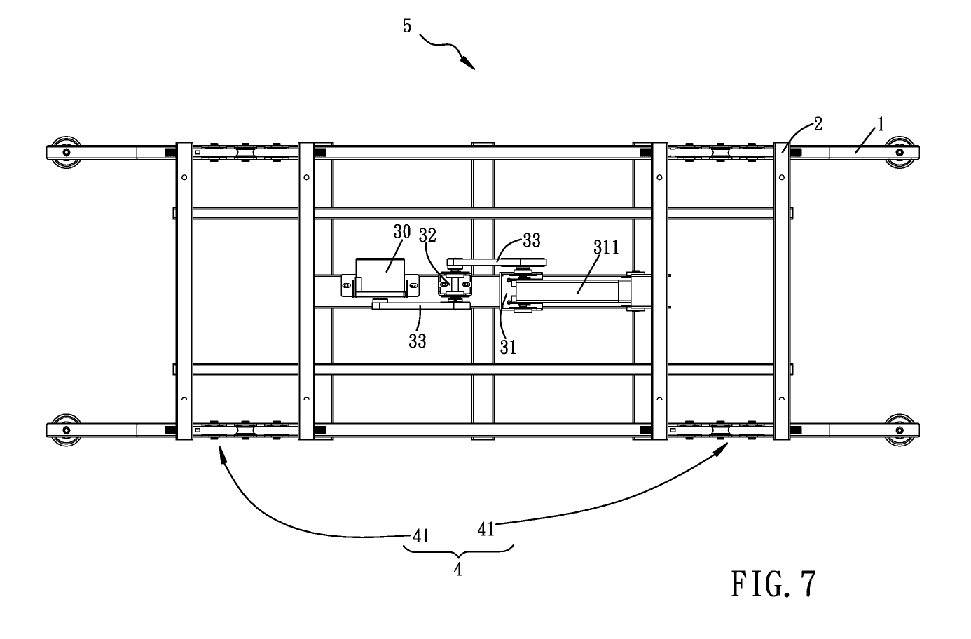

Referring to the drawings in FIGS. 1 and 7, a horizontal vibration apparatus in accordance with the present invention comprises a stand 1, a vibration machine 2 mounted on the stand 1, a first wheel assembly 4 mounted on one side of the stand 1, and a second wheel assembly 5 mounted on the other side of the stand 1.

The vibration machine 2 is able to assemble with a pad (not shown). The vibration machine 2 has an actuating device 3 mounted therein. The actuating device 3 has a motor 30 mounted on the stand 1 and a decelerator 32 mounted on the stand 1 and connected to the motor 30. The motor 30 is provided for generating a rotational force. The decelerator 32 is provided for hierarchically decreasing a rotation speed of the motor 30 to be several different speed levels. Furthermore, the decelerator 32 is also provided for raising the torsion of the force generated by motor 30. Between the motor 30 and the decelerator 32 has a first transmittal belt 33 communicated therewith. The actuating device 32 has a vibrating seat 31 mounted on the stand 1 and connected to the decelerator 32. A second transmittal belt 34 is disposed between the vibrating seat 31 and the decelerator 32 for communicating with the vibrating seat 31 and the decelerator 32. The vibrating seat 31 has an eccentric roller 310 centrally mounted thereon for generating vibration. An arm 311 is mounted on the vibrating seat 31 and connected to the vibration machine 2. Therefore, the motor 30 generates the rotation force to drive the decelerator 32 via the first transmittal belt 33, the decelerator 32 adjusts the rotation speed to drive the vibrating seat 31 via the second transmittal belt 34, and the vibrating seat 31 drives the eccentric roller 310 to convert from the rotation force to a horizontal vibration. The arm 311 transmits the horizontal vibration from the vibrating seat 31 to the vibration machine 2 with the pad. The vibration machine 2 is horizontally vibrated relative to the stand 1.

The first wheel assembly 4 and the second wheel assembly 5 are generally mirror images of each other. In the first wheel assembly 4, the first wheel assembly 4 has two wheel sets 41, 41 respectively mounted on two ends of the stand 1. The two wheel sets 41, 41 of the first wheel assembly 4 are generally minor images of each other. Each wheel set 41 has a rail 6 mounted on the vibration machine 2, a first wheel seat 411 mounted on the stand 1, and two second wheel seats 414, 414 mounted on the stand 1 and respectively positioned on two sides of the first wheel seat 411. The rail 6 is synchronously moved with the vibration machine 2. The rail 6 is moved relative to the stand 1. The first wheel seat 411 has a vertical length longer than that of each of the two second wheel seats 414, 414. The first wheel seat 411 has an upper wheel 412 rotatably mounted therein. Each second wheel seat 414 has a lower wheel 413 rotatably mounted therein. Each of the upper wheel 412 and the lower wheel 414 has a groove 415 annularly defined in a wheel surface thereof for correspondingly meshing the rail 6. The upper wheel 412 and the two lower wheels 413, 413 of the same wheel set 41 of the first wheel assembly 4 are respectively positioned on two reverse sides of the rail 6 for cooperatively securely meshing the rail 6. The two lower wheels 413, 413 are adjacent to two distal ends of the rail 6 and the upper wheel 412 is adjacent to a middle of the rail 6.

The motor 30 generates a force and the decelerator 32 adjusts the force for suiting different weights of different users and raising the torsion of the force generated by motor 30. The eccentric roller 310 and the vibrating seat 31 convert the force to a horizontal vibration. The arm 311 transmits the horizontal vibration from the vibrating seat 31 to the vibration machine 2 with the pad. The wheel sets 41, 41 of both the first wheel assembly 4 and the second wheel assembly 5 mesh the rail 6 such that the vibration machine 2 is stabilized and smoothly moved. Therefore, the present invention provides a horizontal vibration to achieve a massage therapy for massaging a human body.

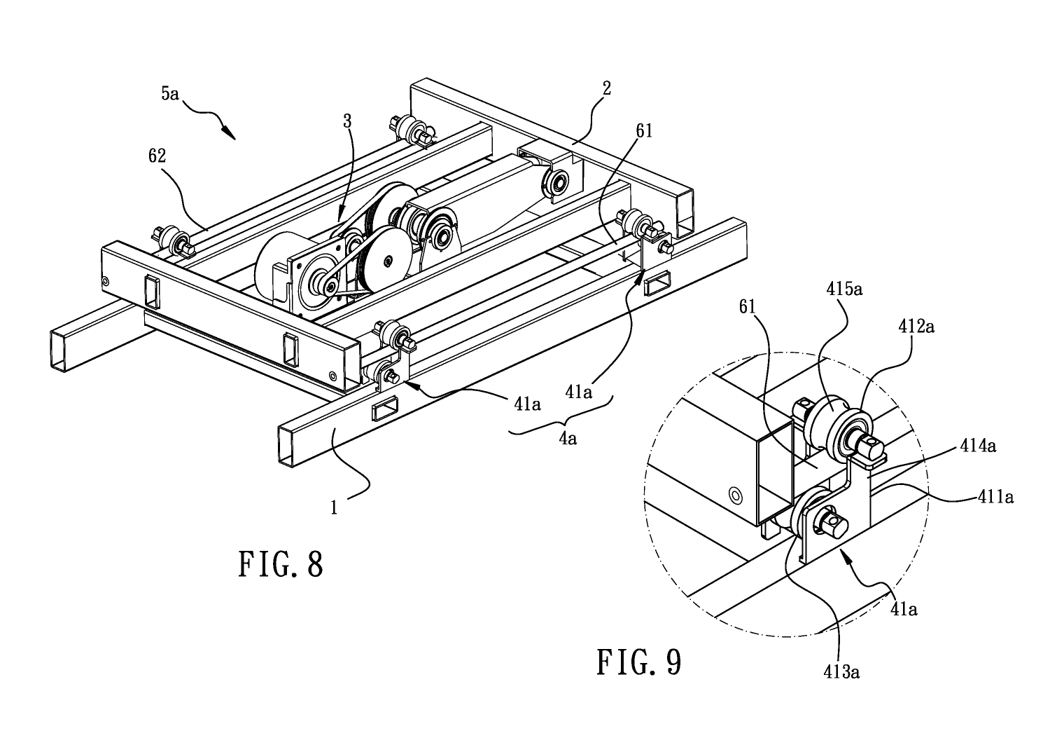

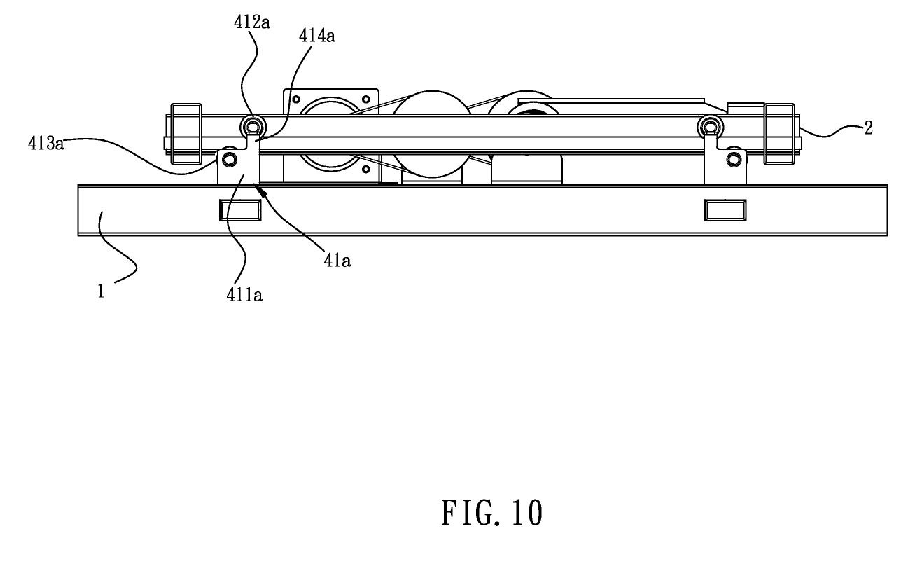

With reference to FIGS. 8-10, that shows a second embodiment of the horizontal vibration apparatus in accordance with the present invention. The elements and effects of the second embodiment which are the same with the first embodiment are not described, only the differences are described. The vibration machine 2 has a first rail 61 and a second rail 62 respectively mounted on two sides thereof. The first rail 61 and the second rail 62 are synchronously moved with the vibration machine 2. The first rail 61 and the second rail 62 are both horizontally movable relative to the stand 1.

The first wheel assembly 4a is mounted on the first rail 61 and the second wheel assembly 5a is mounted on the second rail 62. In the first wheel assembly 4a, the first wheel assembly 4a has two wheel sets 41a, 41a respectively mounted on two ends of the first rail 61. The two wheel sets 41a, 41a of the first wheel assembly 4a are generally mirror images of each other. Each wheel set 41a of the first wheel assembly 4a has a wheel seat 411a mounted on the stand 1 and being adjacent to a distal end of the first rail 61. The wheel seat 411a of the first wheel assembly 4a has a lower wheel 413a rotatably mounted therein. The lower wheel 413a has a groove 415a annularly defined in a wheel face thereof for correspondingly meshing the first rail 61. The wheel seat 411a has two ears 414a upwardly extended therefrom. The wheel seat 411a of the first wheel assembly 4a has an upper wheel 412a rotatably mounted between the two ears 414a. The upper wheel 412a has a groove 415a annularly defined in a wheel face thereof for correspondingly meshing the first rail 61. The upper wheel 412a and the lower wheel 413a of the same wheel set 41a of the first wheel assembly 4a are respectively positioned on two reverse sides of the first rail 61 for cooperatively securely meshing the first rail 61. The lower wheel 413a is adjacent to the distal end of the first rail 61 and the upper wheel 412a is adjacent to a middle of the first rail 61.

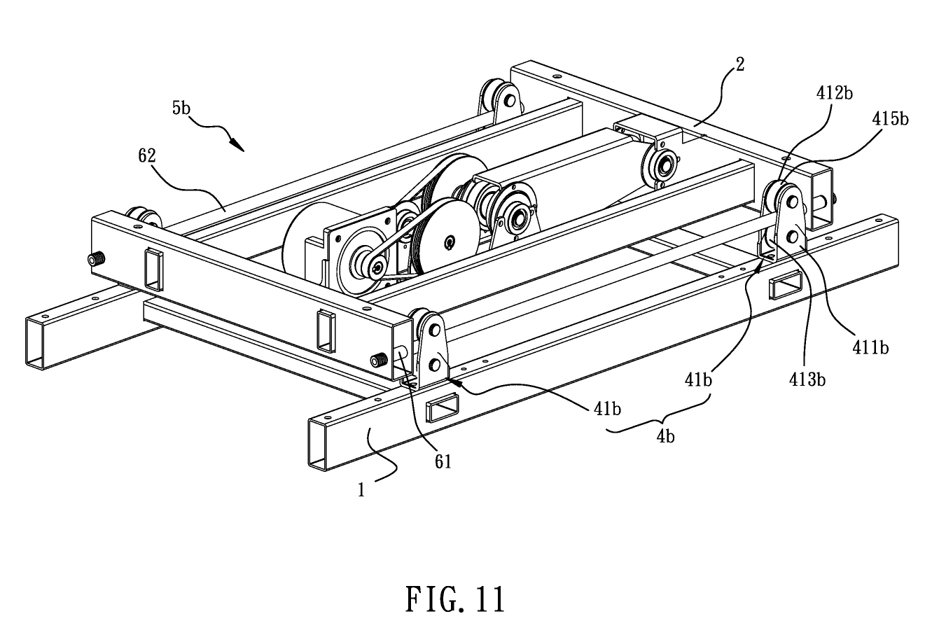

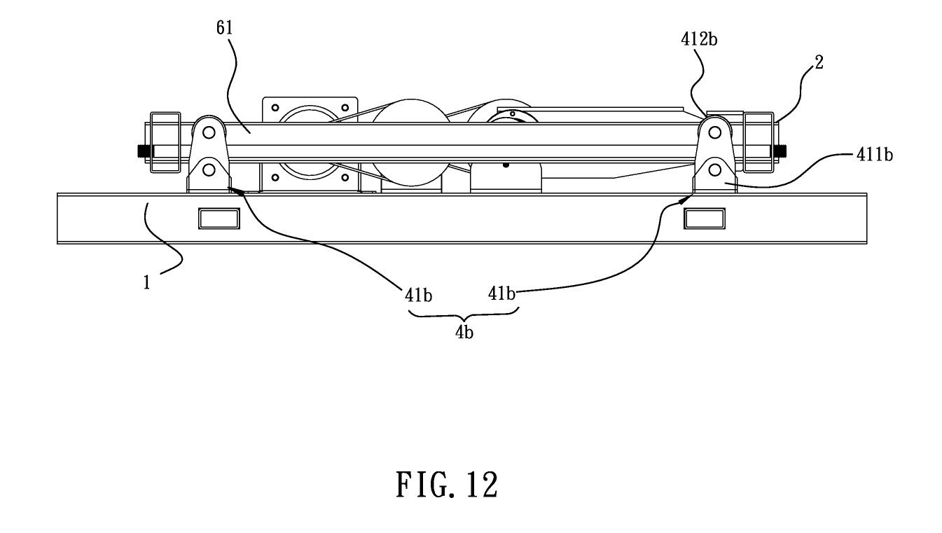

With reference to FIGS. 11-12, that shows a third embodiment of the horizontal vibration apparatus in accordance with the present invention. The elements and effects of the second embodiment which are the same with the second embodiment are not described, only the differences are described. The first wheel assembly 4b is mounted on the first rail 61 and the second wheel assembly 5b is mounted on the second rail 62. In the first wheel assembly 4b, each wheel set 41b has a wheel seat 411b mounted on the stand 1 and being adjacent to the distal end of the first rail 61. The wheel seat 411b has a lower wheel 413b rotatably mounted in a lower part thereof and an upper wheel 412b rotatably mounted in an upper part thereof. The lower wheel 413b is vertically aligned with the upper wheel 412b of the same wheel set 41b. Each of the lower wheel 413b and the upper wheel 412b has a groove 415b annularly defined in a wheel face thereof for correspondingly meshing the first rail 61. The upper wheel 412b and the lower wheel 413b of the same wheel set 41b of the first wheel assembly 4b are respectively positioned on two reverse sides of the first rail 61 for cooperatively securely meshing the first rail 61.

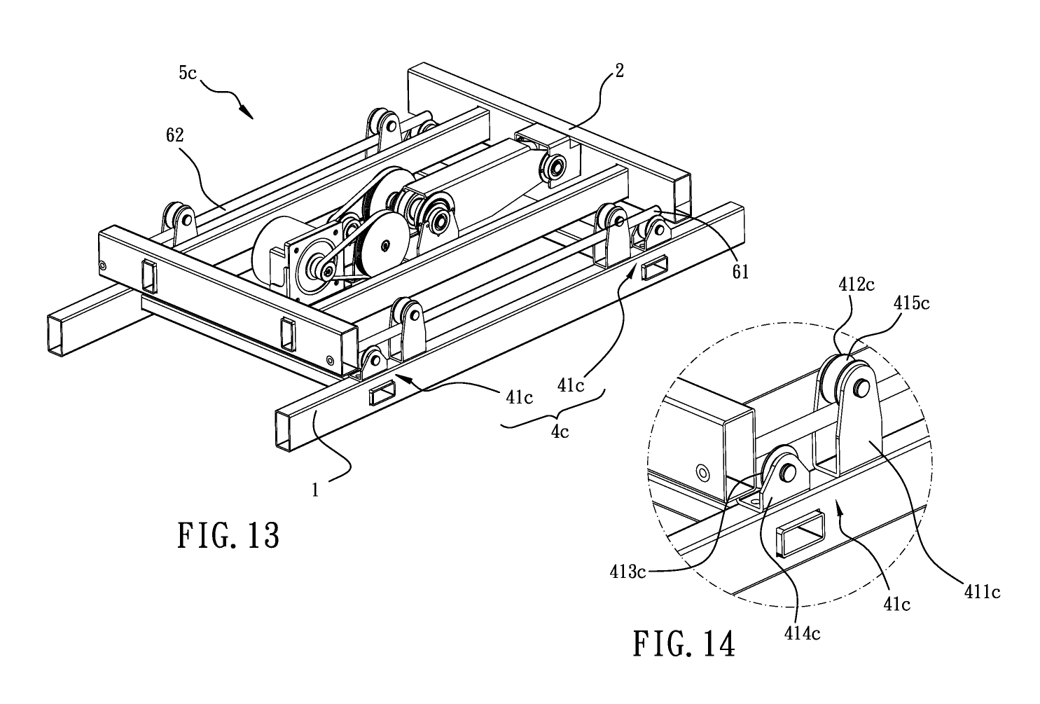

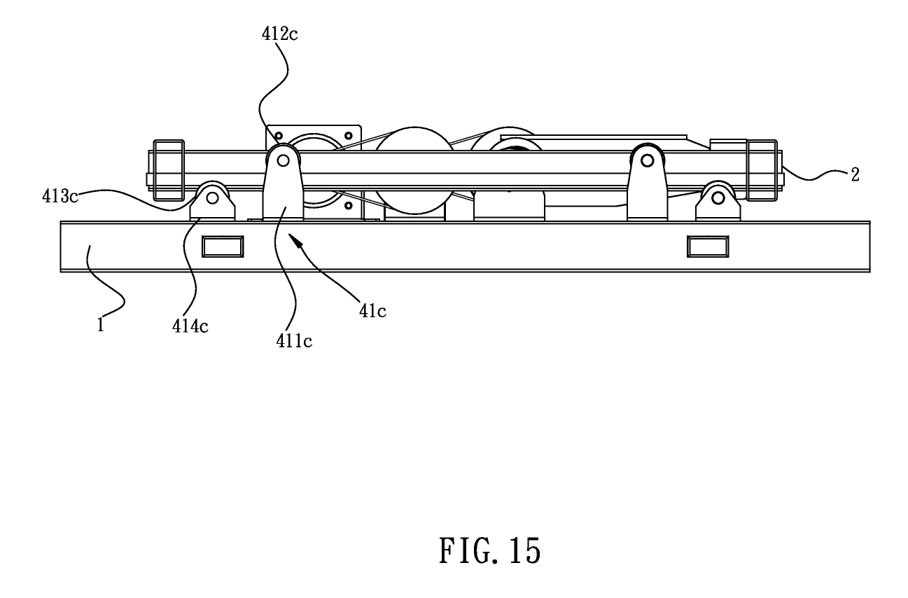

With reference to FIGS. 13-15, that shows a fourth embodiment of the horizontal vibration apparatus in accordance with the present invention. The elements and effects of the fourth embodiment which are the same with the second embodiment are not described, only the differences are described. The first wheel assembly 4c is mounted on the first rail 61 and the second wheel assembly 5c is mounted on the second rail 62. In the first wheel assembly 4c, each wheel set 41c has a first wheel seat 411c and a second wheel seat 414c mounted on the stand 1. The first wheel seat 411c is adjacent to the middle of the first rail 61 and the second wheel seat 414c is adjacent to the distal end of the first rail 61. The first wheel seat 411c has a vertical length longer than that of the second wheel seat 414c. The first wheel seat 411c has a first wheel 412c rotatably mounted on a top thereof. The second wheel seat 414c has a second wheel 413c rotatably mounted on a top thereof. The first wheel 412c is positioned higher than the second wheel 413c. Each of the first wheel 412c and the second wheel 413c has a groove 415c annularly defined in a wheel face thereof for correspondingly meshing the first rail 61. The first wheel 412c and the second wheel 413c of the same wheel set 41c of the first wheel assembly 4c are respectively positioned on two reverse sides of the first rail 61 for cooperatively securely meshing the first rail 61.

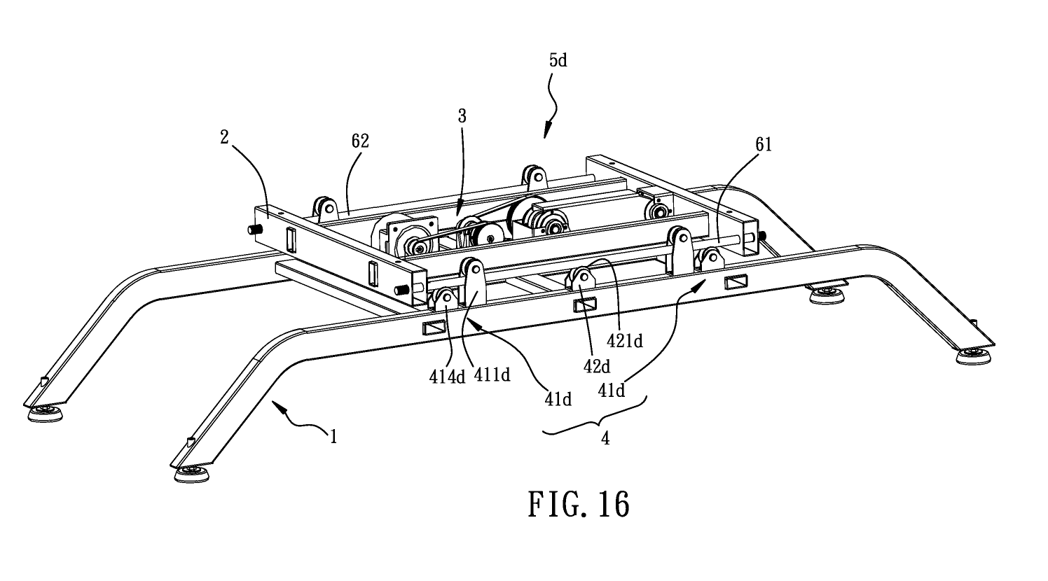

With reference to FIG. 16, that shows a fifth embodiment of the horizontal vibration apparatus in accordance with the present invention. The elements and effects of the fifth embodiment which are the same with the fourth embodiment are not described, only the differences are described. Each of the first wheel assembly 4d and the second wheel assembly 5d has a third wheel seat 42d mounted on the stand 1 and positioned between the two wheel sets 41d, 41d. The third wheel seat 42d has a same vertical length with that of the second wheel seat 414d of each wheel set 41d. The third wheel seat 42d has a third wheel 421d rotatably mounted on a top thereof for meshing a middle of the first rail 61.

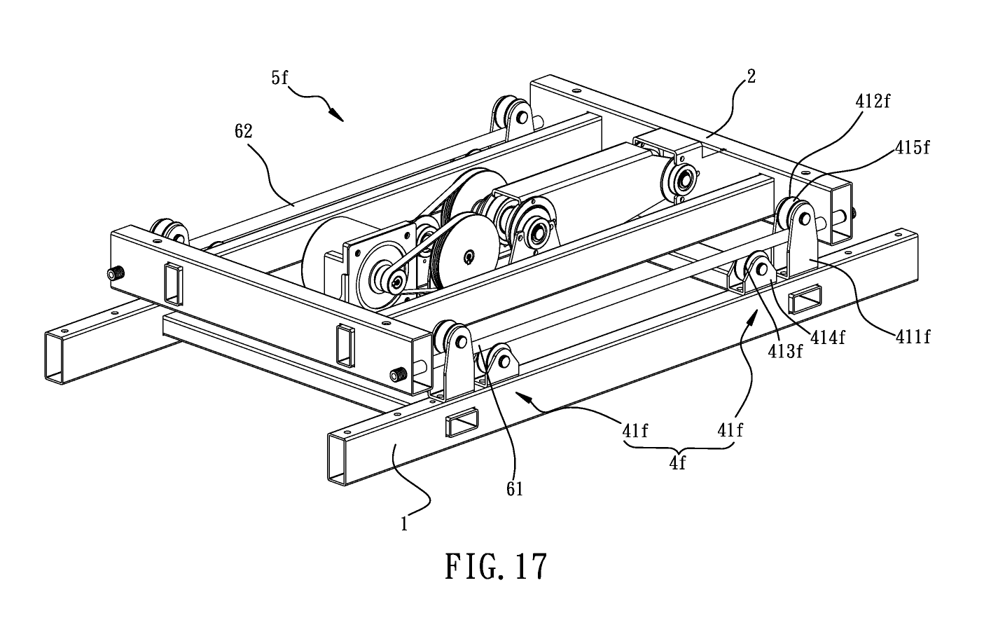

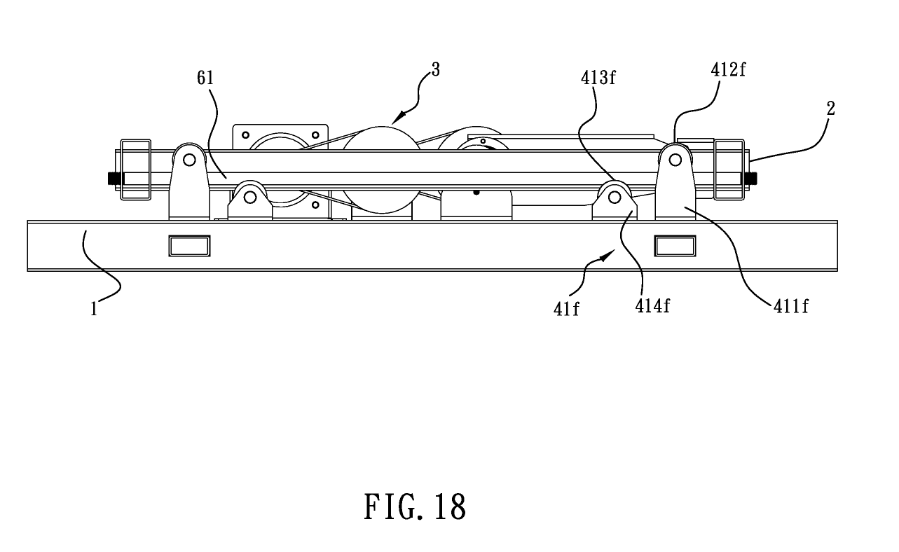

With reference to FIGS. 17-18, that shows a sixth embodiment of the horizontal vibration apparatus in accordance with the present invention. The elements and effects of the sixth embodiment which are the same with the second embodiment are not described, only the differences are described. The first wheel assembly 4f is mounted on the first rail 61 and the second wheel assembly 5f is mounted on the second rail 62. In the first wheel assembly 4f, each wheel set 41f has a first wheel seat 411f and a second wheel seat 414f mounted on the stand 1. The first wheel seat 411f is adjacent to the distal end of the first rail 61. The first wheel seat 411f has a vertical length longer than that of the second wheel seat 414f. The first wheel seat 411f has a first wheel 412f rotatably mounted on a top thereof. The second wheel seat 414f has a second wheel 413f rotatably mounted on a top thereof. The first wheel 412f is relatively positioned higher than the second wheel 413f. Each of the first wheel 412f and the second wheel 413f has a groove 415f annularly defined in a wheel face thereof for correspondingly meshing the first rail 61. The first wheel 412f and the second wheel 413f of the same wheel set 41f of the first wheel assembly 4f are respectively positioned on two reverse sides of the first rail 61 for cooperatively securely meshing the first rail 61.

Although the invention has been explained in relation to its preferred embodiment, it is to be understood that many other possible modifications and variations can be made without departing from the spirit and scope of the invention as hereinafter claimed.

What is claimed is:

1. A horizontal vibration apparatus comprising:
a stand;
a vibration machine movably mounted on the stand, the vibration machine having at least one rail respectively mounted two sides thereof, the vibration machine having an actuating device mounted therein for providing a horizontal vibration effect, the actuating device comprising a motor mounted on the stand, a vibrating seat mounted on the stand and relatively connecting to the motor, and an arm mounted on the vibrating seat and connected to the vibration machine; the motor providing for generating power and relatively driving the vibration seat, the vibrating seat providing for converting the power generated by motor to a horizontal vibration, the arm transmitting the horizontal vibration from the vibrating seat to the vibration machine such that the vibration machine is horizontally moved relative to the stand; and
two wheel assemblies respectively mounted two sides of the stand, the two wheel assemblies being mirror images of each other, the two wheel assemblies respectively meshing with the at least one rail on the two sides of the vibration machine, each wheel assembly having two wheel sets respectively mounted on two ends of the at least one rail, the two wheel sets of the same wheel assembly being mirror images of each other, each wheel set having at least two wheels mounted therein, the at least two wheels of the same wheel set respectively meshing two reverse sides of the at least one rail for stabilizing the horizontal vibration of the vibration machine.

2. The horizontal vibration apparatus as claimed in claim 1, wherein the actuating device has a decelerator mounted on the stand and positioned between the motor and the vibrating seat, the decelerator relatively connected to the motor and the vibrating seat, the decelerator provided for adjusting the power generated by the motor and transmitting the adjusted power to the vibrating seat.

3. The horizontal vibration apparatus as claimed in claim 2 further comprising a first transmittal belt disposed between the motor and the decelerator for communicating with the motor and the decelerator, a second transmittal belt disposed between the vibrating seat and the decelerator for communicating with the vibrating seat and the decelerator.

4. The horizontal vibration apparatus as claimed in claim 1, wherein the vibrating seat has an eccentric roller centrally mounted thereon for generating vibration.

5. The horizontal vibration apparatus as claimed in claim 1, wherein each wheel set has a rail mounted on the vibration machine, a first wheel seat mounted on the stand, and two second wheel seats mounted on the stand and respectively positioned on two sides of the first wheel seat; the first wheel seat having a vertical length longer than that of each of the two second wheel seats, the first wheel seat having an upper wheel rotatably mounted therein, each second wheel seat having a lower wheel rotatably mounted therein, the upper wheel and the two lower wheels of the same wheel set respectively positioned on two reverse sides of the rail for cooperatively securely meshing the rail.

6. The horizontal vibration apparatus as claimed in claim 1, wherein each wheel set has a wheel seat mounted on the stand and being adjacent to the distal end of the at least one rail, the wheel seat having a lower wheel rotatably mounted therein, the wheel seat having two ears upwardly extended therefrom and an upper wheel rotatably mounted between the two ears, the lower wheel being adjacent to the distal end of the at least one rail.

7. The horizontal vibration apparatus as claimed in claim 1, wherein each wheel set has a wheel seat mounted on the stand and being adjacent to the distal end of the at least one rail, each wheel seat having a lower wheel rotatably mounted in a lower part thereof and an upper wheel rotatably mounted in an upper part thereof, the lower wheel vertically aligned with the upper wheel.

8. The horizontal vibration apparatus as claimed in claim 1, wherein each wheel set has a first wheel seat and a second wheel seat mounted on the stand, the second wheel seat being adjacent to a distal end of the at least one rail, the first wheel seat having a vertical length longer than that of the second wheel seat, the first wheel seat having a first wheel rotatably mounted on a top thereof and the second wheel seat of the same wheel set having a second wheel rotatably mounted on a top thereof.

9. The horizontal vibration apparatus as claimed in claim 8, wherein each of the first wheel assembly and the second wheel assembly has a third wheel seat mounted on the stand and positioned between the two wheel sets, the third wheel seat having a same vertical length with that of the second wheel seat of each wheel set, the third wheel seat having a third wheel rotatably mounted on a top thereof for meshing a middle of the first rail.

10. The horizontal vibration apparatus as claimed in claim 1, wherein each wheel has a first wheel seat and a second wheel seat mounted on the stand, the first wheel seat being adjacent to a distal end of the at least one rail, the first wheel seat having a vertical length longer than that of the second wheel seat, the first wheel seat having a first wheel rotatably mounted on a top thereof and the second wheel seat having a second wheel rotatably mounted on a top thereof.

11. The horizontal vibration apparatus as claimed in claim 1, wherein each wheel has a groove annularly defined in a wheel face thereof for correspondingly meshing the rail.
